(19) United States
(12) Patent Application Publication
(10) Pub. No.: US 2015/0116224 A1
(43) Pub. Date: Apr. 30, 2015

(54) PORTABLE ELECTRONIC DEVICE

(71) Applicant: HON HAI PRECISION INDUSTRY CO., LTD., New Taipei (TW)

(72) Inventor: YI-RU CHEN, New Taipei (TW)

(21) Appl. No.: 14/526,750

(22) Filed: Oct. 29, 2014

(30) Foreign Application Priority Data
Oct. 31, 2013 (TW) 102139664

(51) Int. Cl. G06F 3/02; G06F 3/042

(52) U.S. Cl. CPC G06F 3/0202; G06F 3/042
USPC 345/169

(57) ABSTRACT

A portable electronic device includes a base, a keyboard module secured in the base, a display module slidably coupled to the base, and an infrared module movably coupled to the base. The display module is capable of sliding to a retracted position, where the keyboard module is covered by the display module, or to an extended position, whereby the keyboard module is exposed to a user. A positioning area is defined in the infrared module and is configured to recognize an operating location of the display module or keyboard module. The infrared module is capable of moving to a first position, where the display module is located in the positioning area, and a second position, where it is the keyboard module which is located in the positioning area.

### FIELD

The subject matter herein generally relates to portable electronic devices.

### BACKGROUND

Portable electronic devices always have display modules and keyboard modules. The display module can be moved to expose or cover the keyboard module.

### BRIEF DESCRIPTION OF THE DRAWINGS

Implementations of the present technology will now be described, by way of example only, with reference to the attached figures.

FIG. 1 is an exploded, isometric view of an embodiment of a portable electronic device.

FIG. 2 is an enlarged view of circled portion II of FIG. 1.

FIG. 3 is an enlarged view of circled portion III of FIG. 1.

FIG. 4 is an exploded partial view of the keyboard module of FIG. 1.

FIG. 5 is similar to FIG. 4, but viewed from another angle.

FIG. 6 is an assembled, cross-section view of the keyboard module of FIG. 4.

FIG. 7 is an enlarged view of circled portion VII of FIG. 1.

FIG. 8 is an assembled view of the portable electronic device of FIG. 1, the display module in a refracted position.

FIG. 9 is a cross-sectional view taken along line IX-IX of FIG. 8.

FIG. 10 is an enlarged view of circled portion X of FIG. 9.

FIG. 11 is a diagrammatic view of FIG. 8, showing the grids of infrared rays.

FIG. 12 is another assembled view of the portable electronic device of FIG. 1, the display module in an extended position.

FIG. 13 is a cross-sectional view taken along line XIII-XIII of FIG. 12.

FIG. 14 is an enlarged view of circled portion XIV of the portable electronic device of FIG. 13.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure describes a portable electronic device. The portable electronic device includes a base, a keyboard module secured in the base, a display module slidably coupled to the base, and an infrared module movably coupled to the base. The display module is capable of being retracted, where the keyboard module is covered by the display module, or extended, where the keyboard module is not covered by the display module. A positioning area is defined in the infrared module and is configured to recognize a retracted or exposed location of the display module or keyboard module. The infrared module is capable of moving between a first position, where the display module is located in the positioning area, and a second position, where the keyboard module is located in the positioning area.

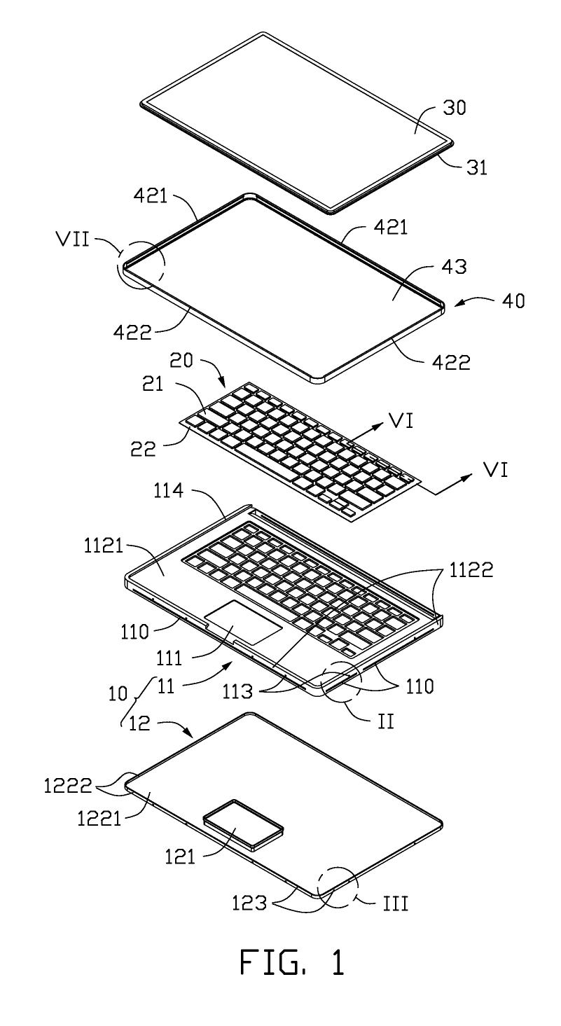

FIG. 1 illustrates an embodiment of a portable electronic device. The portable electronic device includes a base 10, a keyboard module 20 secured in the base 10, a display module 30 slidably coupled to the base 10, and an infrared module 40 movably coupled to the base 10.

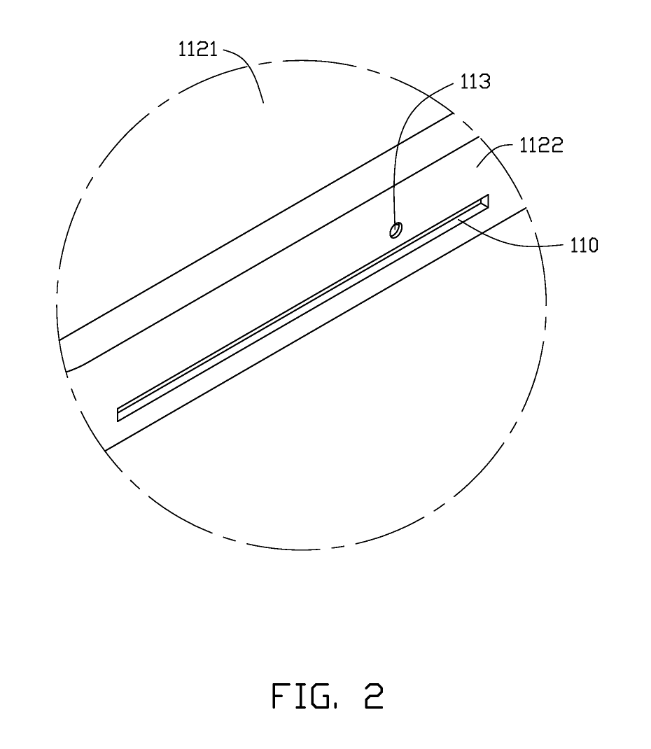

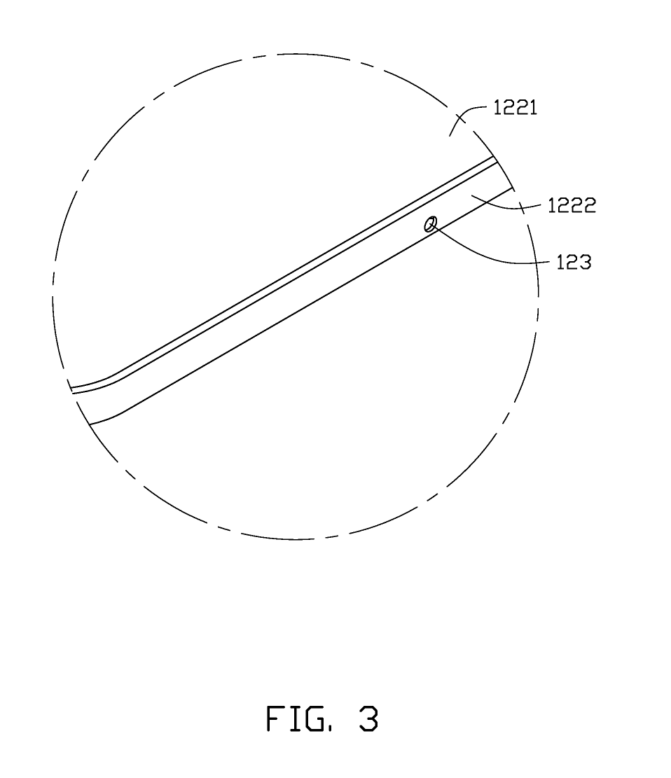

FIGS. 1-3 illustrate the base 10 which includes a chassis 12 and a cover 11 secured upon the chassis 12. The cover 11 is substantially rectangular and includes a top plate 1121 and a pair of side flanges 1122 extending from the top plate 1121. The pair of flanges 1122 is located in opposite sides of the cover 11. A plurality of slots 110 is defined in each side flange 1122. A height of each slot 110 is substantially equal. A plurality of first recesses 113 is defined in each side flange 1122. Each first recess 113 has a substantially equal height. A distance between each recess 113 and the top plate 1121 is less than that between each slot 110 and the top plate 1121. A pair of slide grooves 114 is defined in the opposite sides of the cover 11. A pair of slide portions 31 extends from opposite sides of the display module 30. The slide portions 31 are coupled to the slide grooves 114, thereby the display module 30 is capable of being slidably attached to the cover 11.

The chassis 12 is substantially rectangular and includes a bottom plate 1221 and two pairs of bottom flanges 1222. The two pairs of the bottom flanges 1222 are perpendicular to each other. A bottom flange 1222 of each pair of bottom flanges 1222 is perpendicular to the other. A plurality of second recesses 123 is defined in each bottom flange 1222. Each second recess 123 has a substantially equal height. In one embodiment, each first recess 113 is similar to each second recess 123. A touch panel 121 is located in the chassis 12 and protrudes from the bottom plate 1221. An opening 111 is defined in the top plate 1121 corresponding to the touch panel 121.

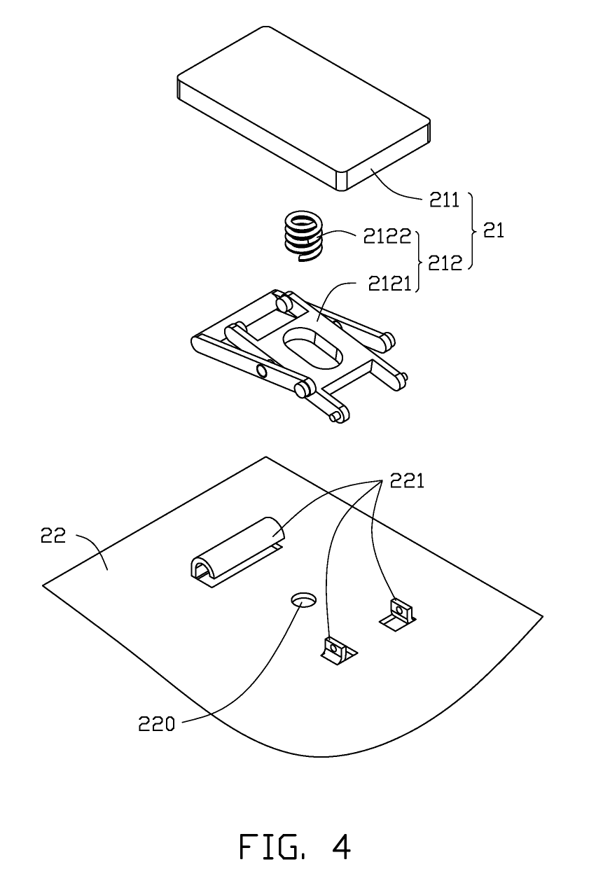

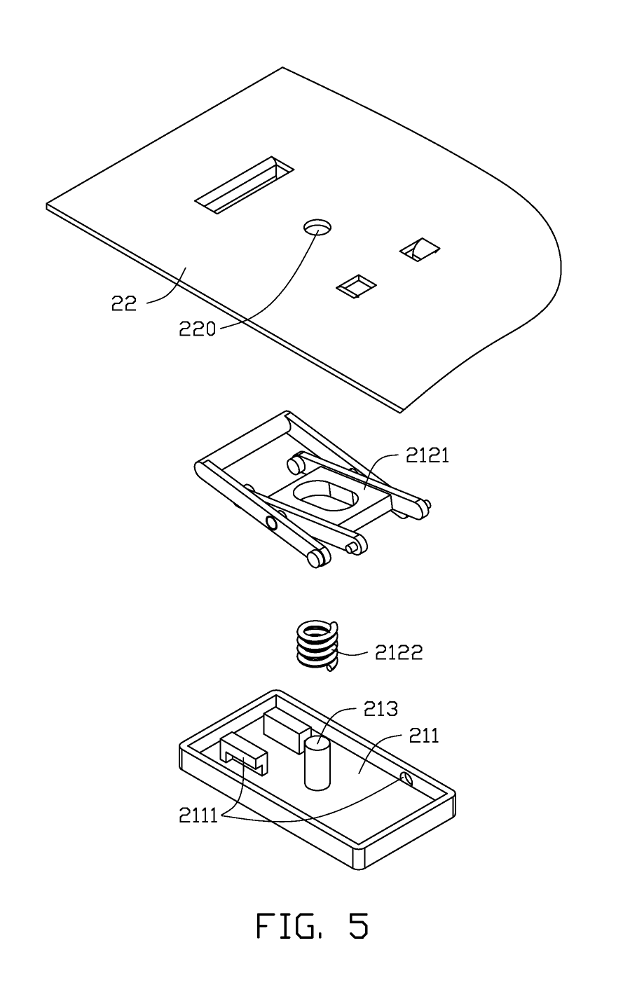

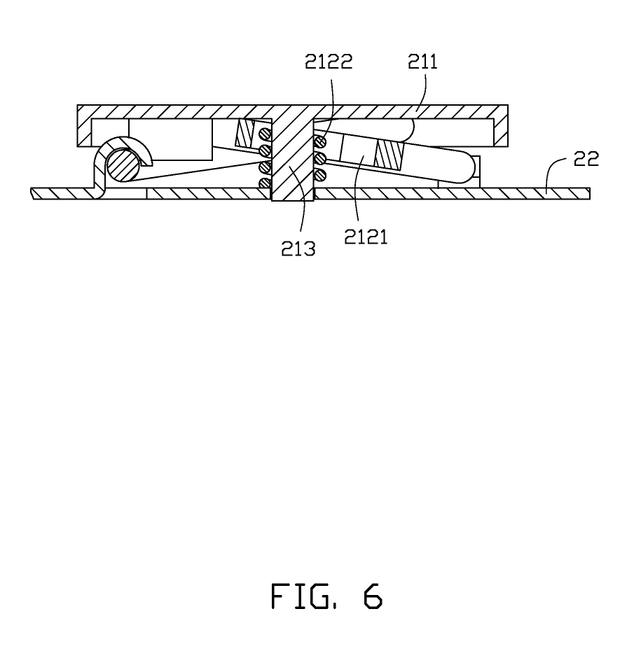

FIGS. 1 and 4-6 illustrate that the keyboard module 20 includes a plurality of keys 21 and a support plate 22. Each key 21 includes a keycap 211, an elastic member 212, and a post 213 secured under the keycap 211. The elastic member 212 includes a support portion 2121 and an elastic portion 2122. A mounting member 2111 is located under the keycap 211 corresponding to the support portion 2121. A plurality of securing members 221 is located in the support plate 22 corresponding to the support portions 2121. Each support portion 2121 is movably coupled between the support plate 22 and a corresponding keycap 211 by the securing members 221 and the mounting member 2111. Each elastic portion 2122 is abutted between the support plate 22 and a keycap 211. In one embodiment, each elastic portion 2122 is a spring. A plurality of through holes 220 is defined in the support plate 22 corresponding to the posts 213. Each post 213 is aligned with a through hole 220. When the elastic portion 2122 is in an original state, the corresponding post 213 is located at a top side of the support plate 22. When the elastic portion 2122 is deformed, the corresponding post 213 is capable of extending to a bottom side of the support plate 22 via the through hole 22.

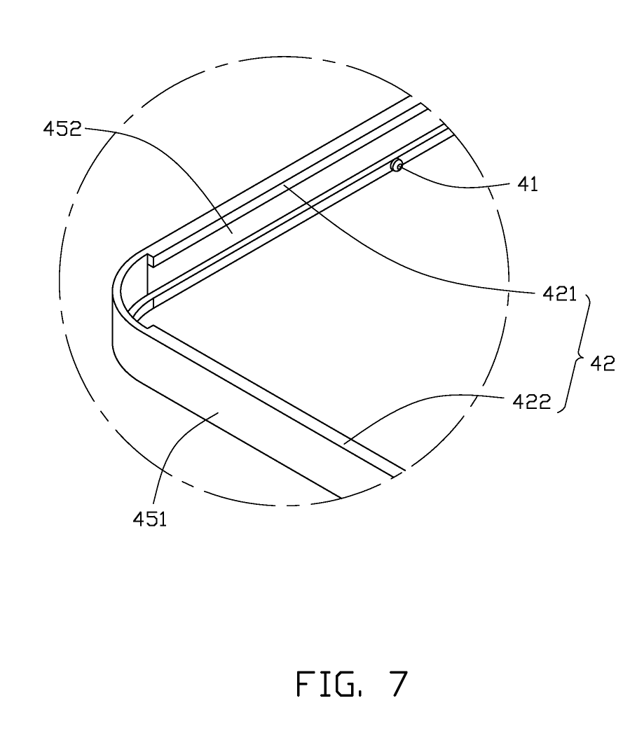

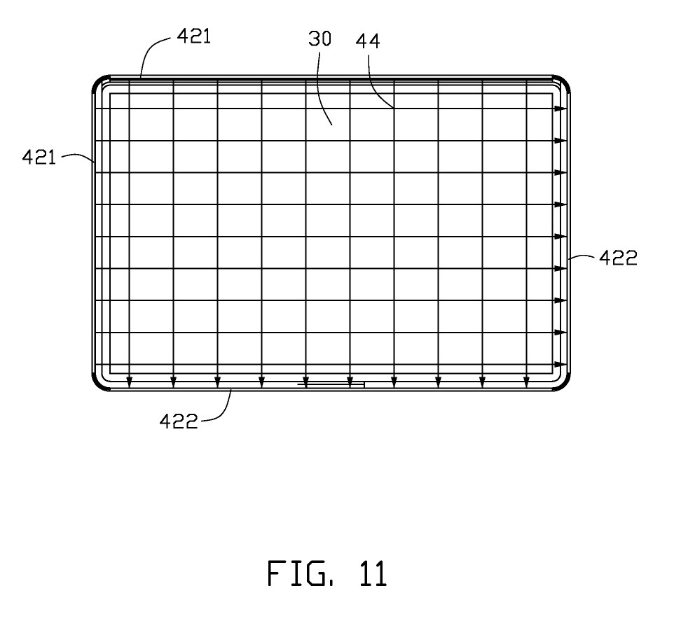

FIGS. 1 and 7 illustrate that the infrared module 40 includes a pair of first flanges 451 and a pair of second flanges 452. Each first flange 451 is substantially perpendicular to each second flange 452. A positioning area 43 is cooperatively defined by the pair of first flanges 451 and pair of second flanges 452. The positioning area 43 is substantially rectangular and is capable of surrounding the base 10. The infrared module 40 includes a plurality of positioning modules 42 located at a same height. Each positioning module 42 includes an emission unit 421 which can emit infrared ray and a receiving unit 422 which can receive infrared ray. The plurality of emission units 421 is evenly spaced in one of the pair of first flanges 451 and one of the pair of second flanges 452. The plurality of receiving units 422 is evenly spaced in the other one of the pair of first flanges 451 and the other one of the pair of second flanges 452. Each emission unit 421 is aligned with each corresponding receiving unit 422. A plurality of infrared grids 44 (see FIG. 11) is formed in the positioning area 43 by the infrared rays transferred between the positioning modules 42. The positioning area 43 is configured to recognize an operating location of the display module 30, of the touch panel 121, and of the keyboard module 20. A plurality of limiting portions 41 protrudes from the infrared module 40 and corresponds to the first recesses 113 and second recesses 123. Each limiting portion 41 is capable of engaging with each first recess 113 or each second recess 123.

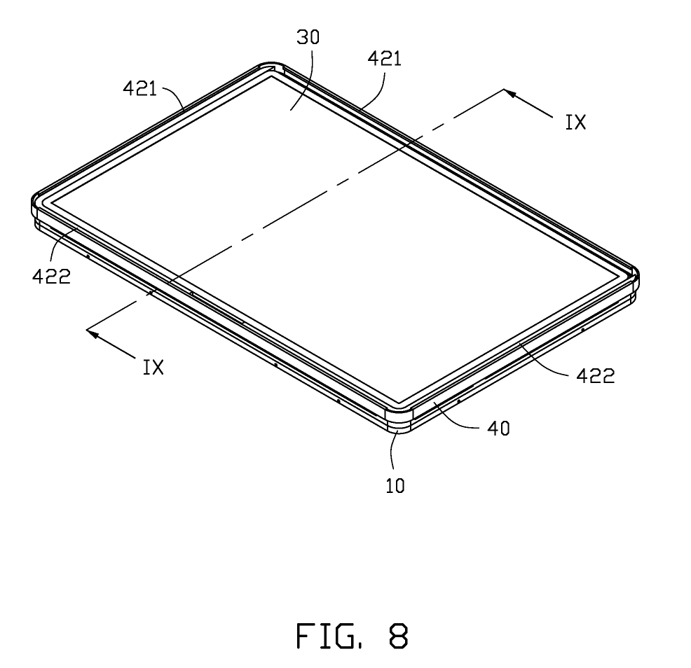

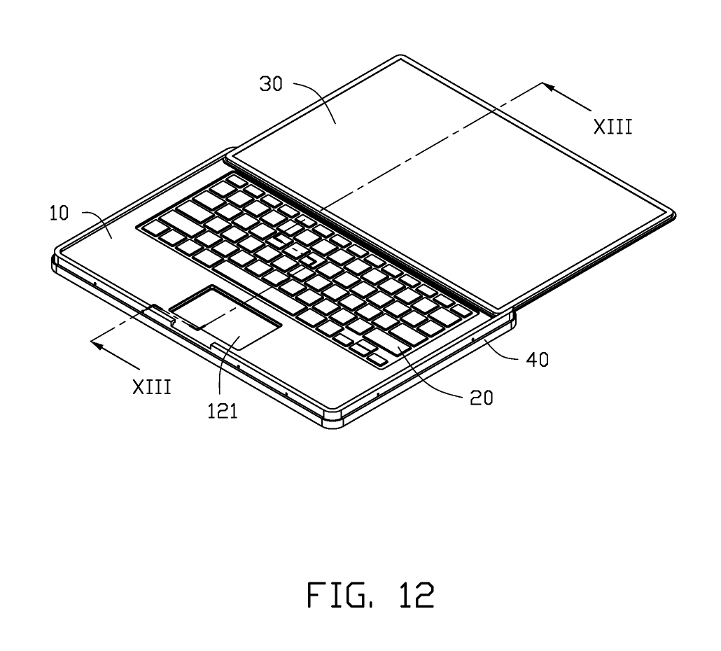

During assembly, the keyboard module 20 is secured inside the base 10 between the chassis 12 and cover 11. The touch panel 121 is exposed via the opening 111, and the plurality of keys 21 is exposed outside the top plate 1121. Each first recess 113 and each second recess 123 are aligned along a direction which is substantially perpendicular to the bottom plate 1221. The pair of slide portions 31 is coupled to the pair of slide grooves 114, thereby the display module 30 is slidably coupled to the base. The display module 30 is slidably changed between a retracted position (see FIG. 8) in which the keyboard module 20 and touch panel 121 are covered by the display module 30, and an extended position (see FIG. 12) in which the keyboard module 20 and touch panel 121 are not covered by the display module 30 and are exposed. The infrared module 40 is movably coupled to the base 10. The pair of first flanges 451 and pair of second flanges 452 are capable of abutting the bottom flange 1222 or the pair of side flanges 1122. When the display module 30 is located in the retracted position, the infrared module 40 is capable of moving between a first position (see FIG. 8) and a second position (see FIG. 12). When the display module 30 is located in the extended and exposed position, the infrared module 40 is limited to be located in the second position.

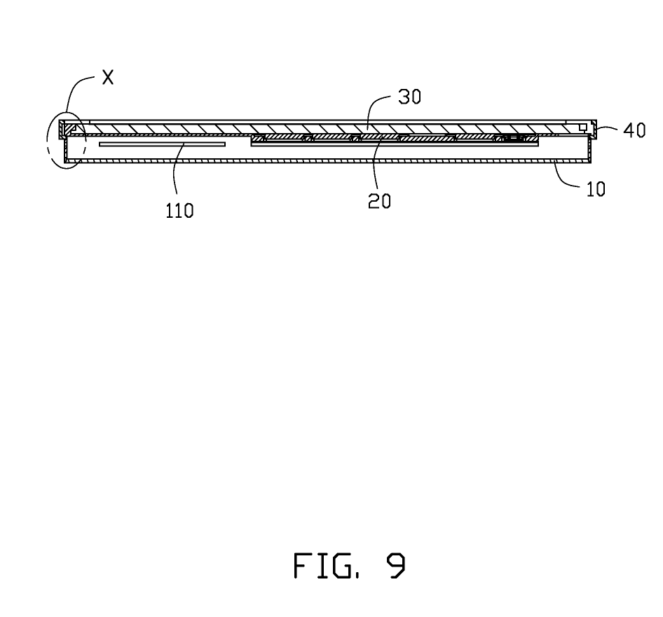

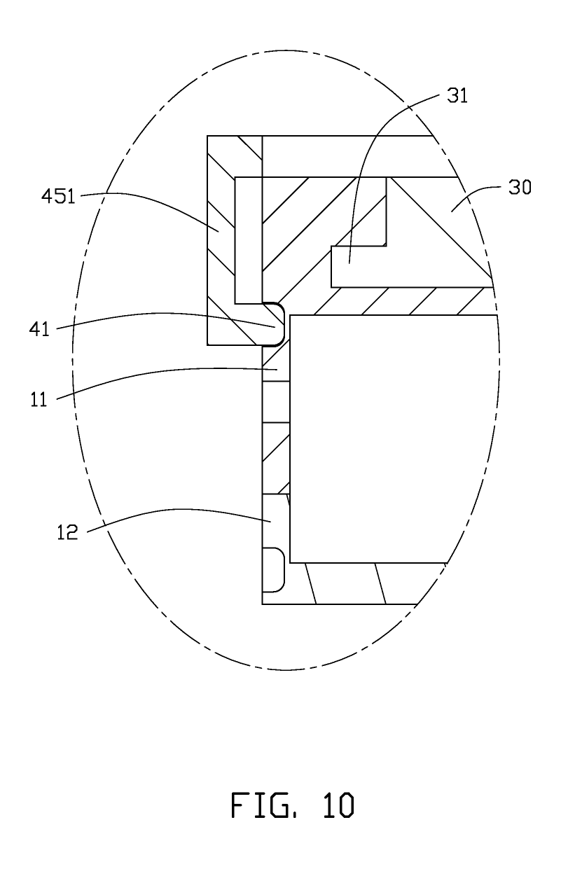

FIGS. 8-11 illustrate the display module 30 located in the refracted position and the infrared module 40 located in the first position. In this position, the display module 30 is surrounded by the pair of side flanges 1122 and is capable of being used as a tablet computer. The pair of first flanges 451 and pair of second flanges 452 abut the pair of side flanges 1122. Each limiting portion 41 is engaged with each first recess 113. Each positioning module 42 is aligned with a top of each side flange 1122, thereby the infrared grids 44 are adjacent to the display module 30 located in the retracted position. The display module 30 is located in the positioning area 43, and the infrared grids 44 are adjacent to the display module 30. When touches of a user are applied to the display module 30, the infrared ray adjacent to the display module 30 is blocked by the touch, thereby the infrared module 40 is capable of recognizing the operation location of the display module 30.

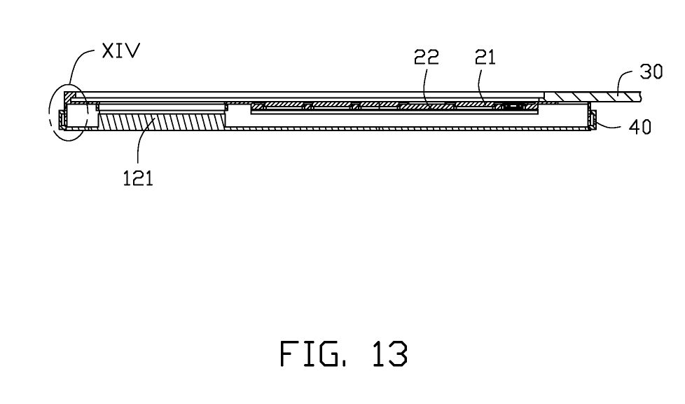

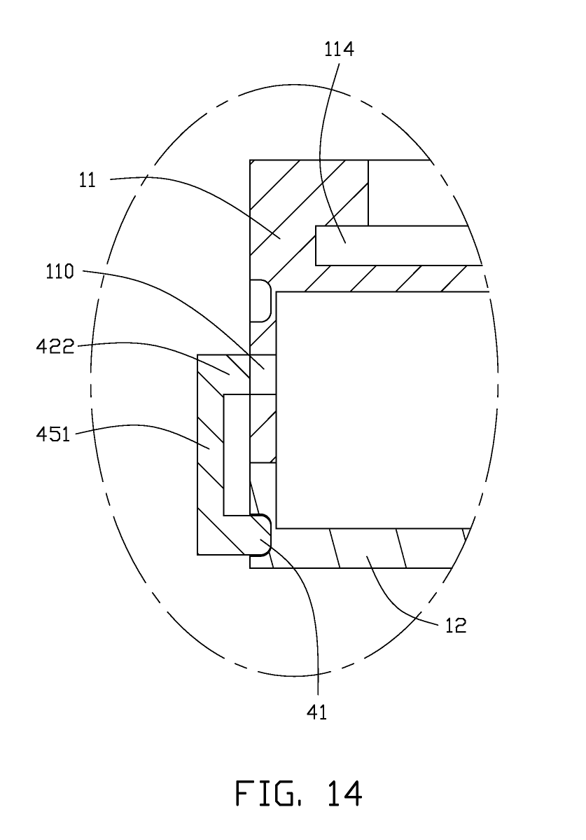

FIGS. 12-14 illustrate the display module 30 located in the extended position and the infrared module 40 located in the second position. The pair of first flanges 451 and pair of second flanges 452 abut the bottom flange 1222. Each limiting portion 41 is engaged with each second recess 123. Positioning modules 42 are aligned with slots 110. The plurality of slots 110 allows the infrared ray to pass through the base 10, thereby the infrared grids 44 are adjacent to the plurality of keys 21 and the touch panel 121. The keyboard module 20 and touch panel 121 are located in the positioning area 43, and the infrared grids 44 are located below the support plate 22 and across and upon the touch panel 121. When a key 21 is pressed, the corresponding elastic member 212 is deformed and allows the corresponding post 213 to move to the bottom side of the support plate 22. The corresponding post 213 blocks the infrared ray below, thereby a location of the key 21 being pressed is capable of recognizing by the infrared module 40. When the key 21 is released, the corresponding elastic member 212 is restored and the corresponding post 213 moves away from the infrared grids 44.

When the touch panel 121 is touched, the infrared ray adjacent to the touch panel 121 is blocked by the touch, thereby the infrared module 40 is capable of recognizing the operation location of the touch panel 121.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A portable electronic device comprising:
a base;
a keyboard module secured in the base;
a display module coupled to the base and slidably trasitionable between a retracted position in which the keyboard module is covered by the display module, and an extended position in which the keyboard module is exposed;
an infrared module movably coupled to the base;
a positioning area defined in the infrared module and configured to recognize an operating location of the display module and the keyboard module,
wherein the infrared module is positionable in a first position, in which the display module is located in the positioning area, and positionable in a second position, in which the keyboard module is located in the positioning area.

2. The portable electronic device of claim 1, wherein when the display module is located in the retracted position, the infrared module is capable of moving between the first position and the second position; and when the display module is located in the extended position, the infrared module is limited to be located in the second position.

3. The portable electronic device of claim 1, wherein the infrared module comprises at least two positioning modules, each positioning module comprises an emission unit which can emit infrared ray and a receiving unit which can receive infrared ray; a plurality of infrared grids are formed by the infrared rays transferred between the positioning modules.

4. The portable electronic device of claim 3, wherein when the infrared module is located in the first position, the infrared grids are adjacent to the display module; when the display module is touched, the infrared ray adjacent to the display module is blocked by the touch, and the infrared module is capable of recognizing the operation location of the display module.

5. The portable electronic device of claim 3, wherein the keyboard module comprises a plurality of keys, when the infrared module is located in the second position, the infrared grids are adjacent to the plurality of keys; each key is capable of pressing and deformed to block the infrared ray, thereby a location of the key being pressed is capable of recognizing by the infrared module.

6. The portable electronic device of claim 5, wherein each key comprises an elastic member and a post, when the key is pressed, the elastic member is deformed and allows the post to move to block the infrared ray; and when the key is released, the elastic member is restored and urges the post to move away from the infrared grids.

7. The portable electronic device of claim 3, further comprising a touch panel located in the base;
wherein when the infrared module is located in the second position, the infrared grids are adjacent to the touch panel; when the touch panel is touched, the infrared ray adjacent to the touch panel is blocked by the touch, and the infrared module is capable of recognizing the operation location of the touch panel.

8. The portable electronic device of claim 3, wherein the base comprises a chassis and a cover secured upon the chassis, a plurality of slots is defined in the cover to allow the infrared ray to pass through the base; when the infrared module is located in the second position, each positioning module is aligned with each corresponding slot.

9. The portable electronic device of claim 8, wherein the infrared module further comprises a limiting portion; a first recess is defined in the cover corresponding to the limiting portion, a second recess is defined in the chassis corresponding to the limiting portion.

10. The portable electronic device of claim 9, wherein when the infrared module is located in the first position, the limiting portion is engaged with the first recess; and when the infrared module is located in the second position, the limiting portion is engaged with the second recess.

11. A portable electronic device comprising:
a base with a first recess and a second recess;
a keyboard module secured in the base;
a display module coupled to the base and slidably trasitionable between a retracted position in which the keyboard module is covered by the display module, and an extended position in which the keyboard module is exposed;
an infrared module movably coupled to the base with a limiting portion, a positioning area defined in the infrared module and configured to recognize an operating location of the display module or keyboard module therein; wherein the limiting portion is capable of engaging with the first recess to make the display module located in the positioning area, or is capable of engaging with the second recess to make the keyboard module located in the positioning area.

12. The portable electronic device of claim 11, wherein the infrared module comprises at least two positioning modules, each positioning module comprises an emission unit which can emit infrared ray and a receiving unit which can receive infrared ray; a plurality of infrared grids are formed by the infrared rays transferred between the positioning modules.

13. The portable electronic device of claim 12, wherein the base comprises a chassis and a cover secured upon the chassis, a first recess is defined in the cover corresponding to the limiting portion, a second recess is defined in the chassis corresponding to the limiting portion.

14. The portable electronic device of claim 13, wherein the cover further comprises a pair of side flanges extending from the cover, when the display module is in the retracted position, the display module is surrounded by the pair of side flanges.

15. The portable electronic device of claim 14, wherein when the limiting portion is engaged with the first recess, each positioning module is aligned with a top of the pair of side flanges, thereby the infrared grids are capable of being adjacent to the display module located in the retracted position.

16. The portable electronic device of claim 15, wherein when the infrared grids are adjacent to the display module and the display module is touched, the infrared ray adjacent to the display module is blocked by the touch, and the infrared module is capable of recognizing the operation location of the display module.

17. The portable electronic device of claim 14, wherein a plurality of slots is defined in the cover to allow the infrared ray to pass through the base; when the limiting portion is engaged with the second recess, each positioning module is aligned with each corresponding slot, thereby the infrared grids are capable of being adjacent to the keyboard module.

18. The portable electronic device of claim 17, wherein the keyboard module comprises a plurality of keys, when the infrared grids are adjacent to the plurality of keys, each key is capable of pressing and deformed to block the infrared ray, thereby a location of the key being pressed is capable of recognizing by the infrared module.

19. The portable electronic device of claim 18, wherein each key comprises an elastic member and a post, when the key is pressed, the elastic member is deformed and allows the post to move to block the infrared ray; and when the key is released, the elastic member is restored and urges the post to move away from the infrared grids.

20. The portable electronic device of claim 17, further comprising a touch panel located in the base; wherein when the limiting portion is engaged with the second recess, the infrared grids are adjacent to the touch panel; when the touch panel is touched, the infrared ray adjacent to the touch panel is blocked by the touch, and the infrared module is capable of recognizing the operation location of the touch panel.
